(19) United States
(12) Patent Application Publication
(10) Pub. No.: US 2009/0191880 A1
(43) Pub. Date: Jul. 30, 2009

(54) Method for using high resolution ribbon maps to design fixed radio network links

(75) Inventors: Tao Wan, Irving, TX (US); Willem DuPlessis, Delray Beach, FL (US)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: Nokia Siemens Networks Oy

(21) Appl. No.: 12/010,722

(22) Filed: Jan. 29, 2008

(51) Int. Cl. H04Q 7/20

(52) U.S. Cl. 455/446; 455/423

(57) ABSTRACT

A method and apparatus for a radio frequency planning tool using high resolution ribbon maps to verify a line of sight condition of fixed radio links for designing a fixed radio network. A method includes generating a radio link between a transmitter and a receiver using a respective generated low resolution map, and acquiring a high resolution ribbon map for the identified radio link between the transmitter and each of the at least one receiver. The method also includes verifying a line of sight condition for each identified radio link using a respective high resolution ribbon map, determining if the line of sight condition for each identified radio link is satisfied, and concluding a design of a fixed radio network between the transmitter and each of the at least one receiver when the line of sight condition is satisfied for each desired radio link, or no LOS link can be found for some sites.

### BACKGROUND OF THE INVENTION

1. Field of the Invention

The present invention generally relates to a wireless communication system, and in particular, to a method and system for a radio frequency (RF) planning tool using high resolution (HR) ribbon maps to verify a line of sight (LOS) condition of fixed radio links for designing a fixed radio network.

2. Description of the Related Art

Generally, successful deployment of a fixed radio network is dependent on two key factors: flexibility in planning RF network layouts and LOS/non-LOS conditions between fixed radio links of the fixed radio network.

Because LOS conditions require an unobstructed view between a transmitter and a receiver of the fixed radio network, carriers face technical and business challenges when planning and deploying LOS-based fixed radio networks.

Generally, certain wireless communication technology can only provide LOS coverage, which means a radio transmission requires a clear path between the transmitter and the receiver. In a LOS radio link, a signal travels over a direct unobstructed path from the transmitter to the receiver. To have a clear LOS, no obstructions must be present between the transmitter and the receiver. Obstructions may include mountains, buildings, trees, and other man-made objects which interfere with the radio LOS and attenuate the transmitted signal.

The characteristics of a radio signal may cause it to occupy a broad cross-section of space, known as a Fresnel Zone, between antennas of the transmitter and the receiver. The Fresnel Zone for a radio beam is an ellipsoidal area immediately surrounding the visual LOS. The Fresnel Zone may vary in thickness depending on the length of the signal path and the frequency of the signal, and includes a plurality of concentric ellipsoidal of revolution which define volumes in the radiation pattern of a circular aperture, e.g. a plurality of Fresnel Zones.

A LOS link requires that a majority of the first Fresnel Zone be free from any obstruction; otherwise, a significant reduction in signal strength may be experienced. Typically, a radio link must have at least 60% of the first Fresnel Zone free as a LOS link. In a traditional LOS fixed radio network design, engineers and technicians must visit the location of the receiver to verify the LOS of each radio link. Unfortunately, this process, known as site surveying, may be very expensive and time consuming.

Accordingly, RF network planning and design is one of the most important elements in deploying a fixed radio network. With improvements in wireless communication technology, it is now possible to use RF planning tools with HR maps to determine a LOS condition between the transmitter and the receiver. The key difference between HR maps and low resolution (LR) maps that are widely used for wireless network design, in addition to differences in resolution, is that HR maps include an additional data layer for buildings and other man-made structures, whereas LR maps do not include such an additional data layer.

Currently, to design a fixed radio network covering a large area, such as an area surrounding a large city, RF planning tools may use mixed resolution maps. Typically, HR maps are used for urban areas and LR maps are used for suburban and rural areas. However, to design the fixed radio network, current RF planning tools are only able to verify LOS conditions between fixed radio links contained in HR maps. Accordingly, current RF planning tools are unable to verify LOS conditions of fixed radio links contained in all other non-HR map areas.

Accordingly, HR maps are usually defined by polygons which cover every fixed radio link and additionally the area therebetween, increasing the time required to design the fixed radio network and increasing the costs associated with generating large polygon-shaped HR maps for large coverage areas.

Thus, to optimize a wireless communication system, satisfying LOS condition requirements are crucial. Accordingly, what is needed is an improved method and system to verify LOS conditions between fixed radio links for providing a cost-effective and time-efficient fixed radio network design.

### SUMMARY OF THE INVENTION

The present invention provides a method and system using HR ribbon maps to verify a LOS condition of fixed radio links for designing a fixed radio network using a RF planning tool.

In accordance with one embodiment of the present invention, there is provided a method. The method includes generating a low resolution map for designing a coverage area between a transmitter and at least one receiver, identifying at least one radio link between the transmitter and each of the at least one each receiver; and acquiring a high resolution ribbon map for each radio link identified between the transmitter and each of the at least one receiver. The method also includes verifying a line of sight condition for each identified radio link using a respective high resolution ribbon map, determining if the line of sight condition for each identified radio link is satisfied, and concluding a design of a fixed radio network between the transmitter and the at least one receiver when the line of sight condition is verified for each identified radio link, or the line of sight condition cannot be verified for any of the identified at least one radio link.

In accordance with another embodiment of the present invention, there is provided a method including generating a mixed resolution map for designing a coverage area between a transmitter and at least one receiver, identifying at least one radio link between the transmitter and each of the at least one receiver, and acquiring a high resolution ribbon map for each radio link identified between the transmitter and each of the at least one receiver. The method also includes verifying a line of sight condition for each identified radio link using a respective high resolution ribbon map, determining if the line of sight condition for each identified radio link is satisfied, and concluding a design of a fixed radio network between the transmitter and each of the at least one receiver when the line of sight condition is satisfied for each identified radio link, or the line of sight condition cannot be verified for any of the identified at least one radio link.

In accordance with another embodiment of the present invention, there is provided a method including generating a low resolution map for designing a coverage area between a transmitter and at least one receiver, identifying at least one candidate radio link between the transmitter and each of the at least one receiver, and acquiring a high resolution ribbon map for each candidate radio link identified between the transmitter and each of the at least one receiver. The method also includes verifying a line of sight condition for each identified candidate radio link using a respective high resolution ribbon map, and removing each identified candidate radio link failing to satisfy the verified line of sight condition for designing a fixed radio network between the transmitter and each of the at least one receiver.

In accordance with another embodiment of the present invention, there is provided a computer program product embodied on a computer readable medium. The computer program is configured to control a processor to perform generating a low resolution map for designing a coverage area between a transmitter and at least one receiver, identifying at least one radio link between the transmitter and each of the at least one receiver, and acquiring a high resolution ribbon map for each radio link identified between the transmitter and each of the at least one receiver. The computer program is also configured to control the processor to perform verifying a line of sight condition for each identified radio link using a respective high resolution ribbon map, determining if the line of sight condition for each identified radio link is satisfied, and concluding a design of a fixed radio network between the transmitter and each of the at least one receiver when the line of sight condition is satisfied for each identified radio link, or the line of sight condition cannot be verified for any of the identified at least one radio link.

In accordance with another embodiment of the present invention, there is provided a computer program product embodied on a computer readable medium. The computer program is configured to control a processor to perform generating a low resolution map for designing a coverage area between a transmitter and at least one receiver, identifying a candidate radio link between the transmitter and each of the at least one receiver, and acquiring a high resolution ribbon map for the each candidate radio link identified between the transmitter and each of the at least one receiver. The computer program is also configured to control the processor to perform verifying a line of sight condition for each identified radio link using a respective high resolution ribbon map, and removing each identified radio link failing to satisfy the verified line of sight condition for designing a fixed radio network between the transmitter and each of the at least one receiver.

### BRIEF DESCRIPTION OF THE DRAWINGS

Further embodiments, details, advantages, and modifications of the present invention will become apparent from the following detailed description of the preferred embodiments which is to be taken in conjunction with the accompany drawings, in which:

FIG. 1 illustrates a radio link of a wireless network requiring LOS to operate.

FIG. 2 illustrates a wireless network area with a number of radio sites requiring LOS to operate and a planning connection of these radio sites according to a prior art method.

FIG. 3a illustrates a LOS condition verification between four radio links according to a prior art method.

FIG. 3b illustrates a LOS condition verification between six radio links according to another prior art method.

FIG. 4 illustrates a flow diagram for creating a fixed radio network design and for verifying LOS conditions between fixed radio links using HR ribbon maps according to an embodiment of the present invention.

FIG. 5 illustrates a flow diagram for verifying a LOS condition between six radio links using HR ribbon maps according to an embodiment of the present invention.

FIG. 6 illustrates a flow diagram for performing a radio link design and for verifying a LOS condition between radio links using HR ribbon maps according to another embodiment of the present invention.

FIG. 7 illustrates an embodiment of the present invention that is a computer program product embodied on a computer readable medium, the computer program being configured to control a processor to perform at least the method described in FIG. 4 and the method described in FIG. 6, in accordance with an embodiment of the present invention.

### DETAILED DESCRIPTION OF THE PREFERRED EMBODIMENTS

Reference will now be made in detail to preferred embodiments of the present invention, examples of which are illustrated in the accompanying drawings. In accordance with an embodiment of the present invention, there is provided a method, a system, and an apparatus to define a fixed radio network design and a verification of LOS conditions between fixed radio links using HR ribbon maps.

According to preferred embodiments of the present invention, a fixed radio network may include a single point-to-point radio link, such as a microwave link, a point-to-multi-point network, e.g. a local multipoint distribution service, or a meshed network.

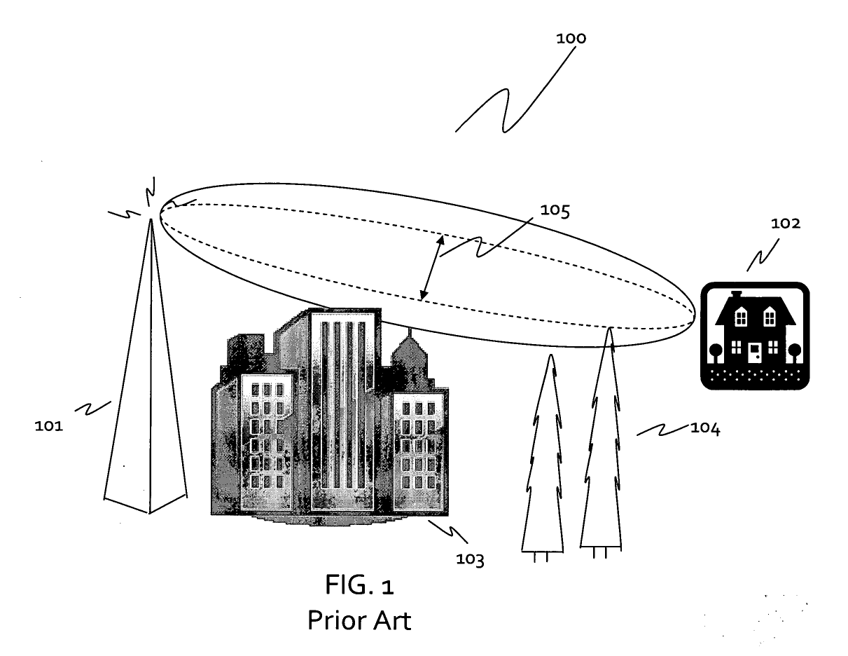

FIG. 1 illustrates a radio link of a wireless network requiring LOS to operate. The radio link 100 includes transmitter 101, receiver 102, obstructions 103, 104, and first Fresnel Zone 105. As shown, first Fresnel Zone 105 should be free from obstructions 103, 104 for optimum performance of the radio link between transmitter 101 and receiver 102. Preferably, at least 60% of the first Fresnel Zone should be unobstructed.

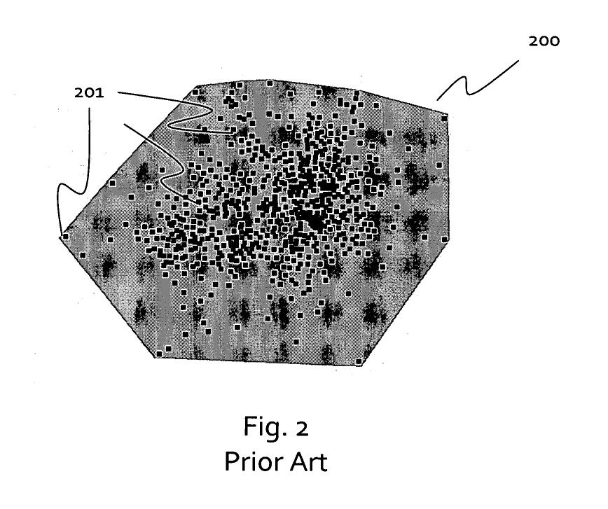

FIG. 2 illustrates a wireless network area with a number of radio sites, each radio site requiring a LOS to operate and a planning connection of these radio sites according to a known method. FIG. 2 includes shaded area 200 where a wireless network with a LOS requirement is to be deployed.

Each dot 201 represents a fixed radio site location within area 200. If fixed radio networks are designed to connect the fixed radio site locations, HR maps are needed to cover the entire shaded area such that any possible radio link between the fixed radio site locations must be completely contained within area 200. Because HR maps are very expensive and very time consuming to create for large areas, carriers face technical and business challenges when planning a deployment of the fixed radio networks operating under LOS conditions. Accordingly, the cost associated with current RF planning tools using HR maps to verify LOS conditions between fixed radio links is proportional to the map size, e.g. the area being mapped.

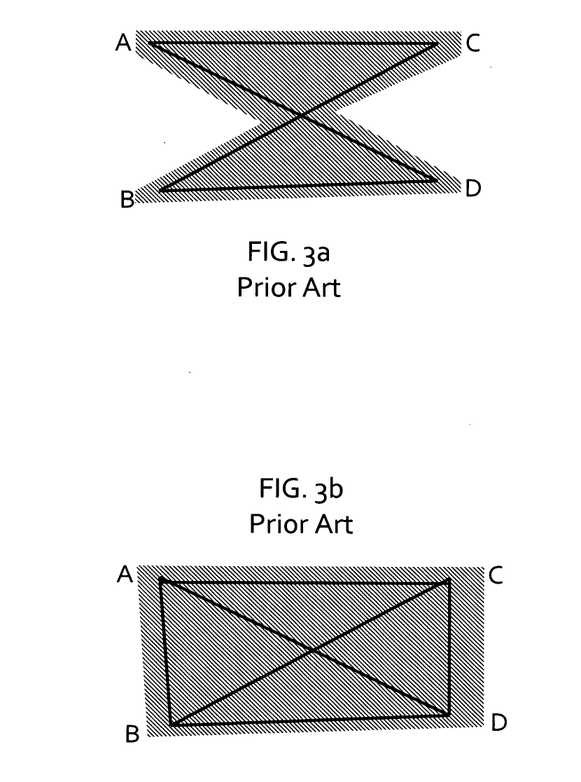

FIG. 3a illustrates a LOS condition verification between four radio links according to a prior art method. FIG. 3b illustrates a LOS condition verification between six radio links according to another prior art method.

Referring to FIG. 3a, according to current RF planning tools, if the LOS conditions of four radio links, AC, AD, BC, BD, need to be verified, the RF planning tool must use HR maps patterned to cover the shaded area in FIG. 3a, and the remaining areas may use LR maps or may have no map data at all. A fixed radio network design according to FIG. 3a would be expensive and time consuming to create because LOS condition verification between the four radio links would require HR maps covering every fixed radio link and the area therebetween.

Referring to FIG. 3b, according to current RF planning tools, if the LOS conditions of six radio links, AB, AC, AD, BC, BD, CD, need to be verified, the RF planning tool must use HR maps patterned to cover the shaded area in FIG. 3b, and the remaining areas may use LR maps. A fixed radio network design according to FIG. 3b would also be expensive and time consuming to create because LOS condition verification between the six radio links would require HR maps covering every fixed radio link and the area therebetween.

Accordingly, preferred embodiments of the present invention provide methods and systems for a RF planning tool using HR ribbon maps to verify a LOS condition between fixed radio links for a cost-effective, time-efficient fixed radio network design.

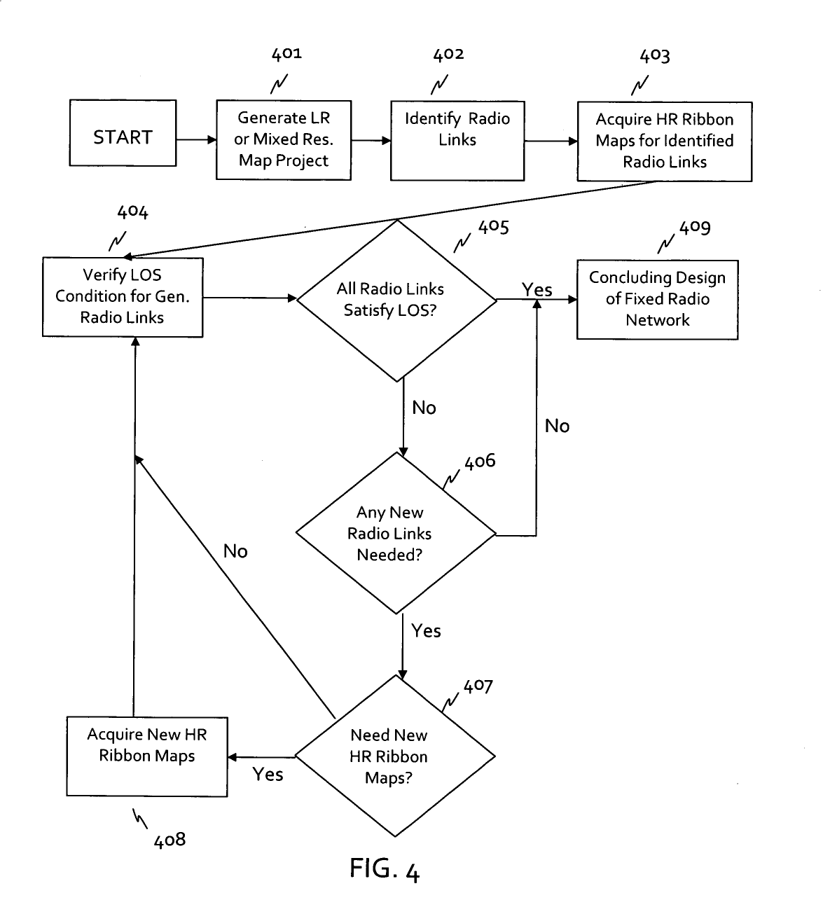

FIG. 4 illustrates a flow diagram for creating a fixed radio network design and for verifying LOS conditions between fixed radio links using HR ribbon maps according to an embodiment of the present invention. The process illustrated in FIG. 4, and described below, may be an iterative process because when a radio link has no LOS and new radio links are added, new HR ribbon maps for the new radio links may need to be acquired.

Each fixed radio link may connect a radio unit to at least one other radio unit, whereby each radio unit may be a transmitter and/or a receiver. The transmitter may include a local multipoint distribution system (LMDS) base station. The receiver may include a LMDS customer premium equipment (CPE).

In step 401, a LR map is generated for designing a coverage area between one radio unit serving as a transmitter and at least one radio unit serving as a receiver. At this step, a LOS condition cannot be verified using the low resolution map.

Alternatively, a mixed resolution map may be generated for the initial design of the fixed radio network. Accordingly, the mixed resolution map may include at least one HR map for mapping a dense urban area and at least one LR map for mapping an area including at least one of a suburban area and a rural area. The dense urban area may include a highly dense area having a number of rooftop radio sites.

In step 402, at least one radio link is identified between the transmitting radio unit and each receiving radio unit.

In step 403, a HR ribbon map is acquired only for the corridor along each radio link identified between the transmitting radio unit and each receiving radio unit. Whereas, the other areas not contained within the HR ribbon maps may only include LR map data. Hence, the corridors along each radio link identified between the transmitting radio unit and each receiving radio unit are a LR map embedded with a ribbon of a HR map.

The HR ribbon maps may include a high resolution ribbon having a minimum width equivalent to a first Fresnel Zone plus a map error. Further, the HR ribbon maps may be created from aerophotos. Map error may be introduced during many stages of the map creation process. In addition, map error may include the global positioning system (GPS) coordinate errors of the radio site. Otherwise, a HR ribbon map may not fully contain the required first Fresnel zone clearance. The first Fresnel Zone for a radio signal is an ellipsoidal area immediately surrounding the visual LOS between the transmitting radio unit and each receiving radio unit. The first Fresnel Zone may vary in thickness depending on the length of the radio signal path and the frequency of the radio signal. It is preferable that a majority of the first Fresnel Zone is free from any obstruction; otherwise, a significant reduction in signal strength may be experienced. Preferably, the first Fresnel Zone should be at least 60% unobstructed.

The width of the first Fresnel Zone may also be dependent on the available area for radio unit antenna placement at each radio site or location. A radio site may be a tower, a utility pole, a water tank, part of a building rooftop, or an entire building rooftop. A radio may be a LMDS base station or a CPE. If a comparatively large area is available for antenna placement, such as the rooftop of the building, a wider HR ribbon may be used so that the first Fresnel Zone of the link will be contained no matter which part of rooftop is used for the radio antenna placement. This provides more flexibility to verify the LOS condition for the radio link to each of the available locations and find the best one for the radio antenna. However, if a site only has very limited room horizontally for antenna placement, such as a tower site, a narrower HR ribbon may be used to reduce the costs associated with mapping used for the design of the fixed radio network.

Further, the HR ribbon maps may include HR ribbons having the same ribbon width for each generated radio link, or may include HR ribbons having different widths for each generated radio link, as long as the aforementioned minimum width is satisfied.

Hence, the HR ribbon width is a trade-off between design flexibility and map cost.

Although the HR ribbons are illustrated as having straight edges, embodiments of the present invention also include HR ribbons having various shapes and sizes.

In step 404, a LOS condition is verified for each identified radio link using a respective HR ribbon map. The LOS condition may only be verified using the HR ribbon maps. Hence, other non-HR maps are unable to verify the LOS condition of the radio links identified between transmitting radio unit and each receiving radio unit.

In step 405, a determination is made whether the LOS condition is satisfied for each identified radio link.

In step 406, a determination is made whether a new radio link is required to replace an identified link when the LOS condition is not satisfied for each identified radio link. Further, a new radio link is generated when determining the new radio link is required.

In steps 407 and 408, respectively, a determination is made whether a new HR ribbon map is required for each new radio link when the new radio link is determined to be required. Further, a new HR ribbon map is acquired when determining the new HR ribbon map is required for each new radio link.

Subsequently, the process returns to step 404 for verifying the LOS condition for each new generated radio link using a respective new HR ribbon map. Further, a determination is made whether the LOS condition is satisfied for each new generated radio link.

Steps 404 to 408 are iteratively repeated until the LOS condition is satisfied for all radio links identified between the transmitting radio unit and each receiving radio unit, or a determination is made to not cover this coverage area, upon which a design of the fixed radio network is concluded at step 409.

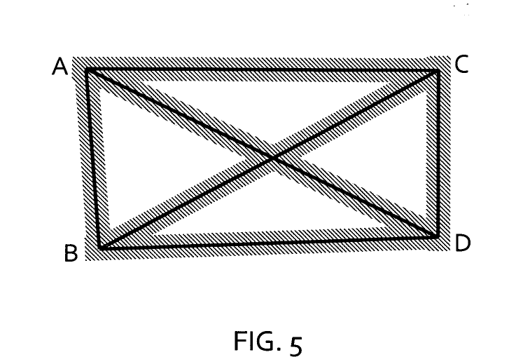

FIG. 5 illustrates a flow diagram for verifying a LOS condition between six radio links using HR ribbon maps according to an embodiment of the present invention.

Referring to FIG. 5, if a LOS condition for each six radio links AB, AC, AD, BC, BD and CD needs to be verified using HR ribbon maps using the process described above in FIG. 4, then HR ribbon maps may only be needed for the corridors along the radio links identified between A and B, A and C, etc. The shaded areas represent HR ribbon map areas. All of the other areas have no impact on radio link LOS conditions. Hence, these areas may only have LR map data or no data, depending on the RF planning tools. As previously noted, the cost and time of HR maps may be proportional to the map size. By using HR ribbon maps to verify the LOS condition of radio links between a transmitting radio unit and a receiving radio unit, the total HR map cost and available time for the link design of a fixed radio network may be significantly reduced.

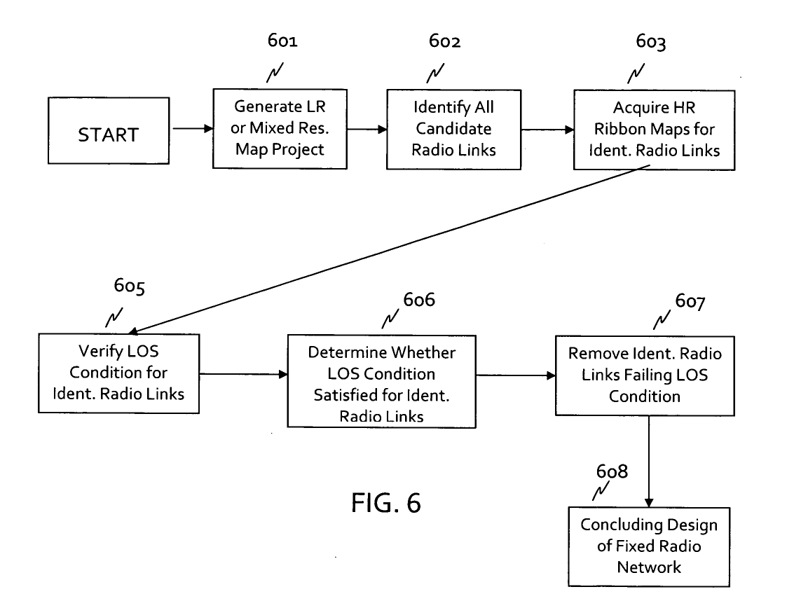

FIG. 6 illustrates a flow diagram for performing a radio link design and for verifying a LOS condition between radio links using HR ribbon maps according to another embodiment of the present invention.

Each fixed radio link may connect one radio unit to another radio unit though one radio unit may have multiple links connected to multiple radio units, whereby each radio unit may be a transmitter and/or a receiver. The transmitter may include a Wi-Fi backhaul radio. The receiver may include another Wi-Fi backhaul radio.

In step 601, a LR map is generated for designing a coverage area between the transmitting radio unit and at least one receiving radio unit. At this step, a LOS condition cannot be verified using the low resolution map.

Alternatively, a mixed resolution map may be generated for the initial design of the fixed radio network. Accordingly, the mixed resolution map may include at least one HR map for mapping a dense urban area and at least one LR map for mapping an area including at least one of a suburban area and a rural area. The dense urban area may include a highly dense area having a number of rooftop radio sites.

In step 602, all candidate radio links are identified between the transmitting radio unit and each receiving radio unit.

In step 603, a HR ribbon map is acquired only for the corridor along each candidate radio link identified between the transmitting radio unit and each receiving radio unit. Whereas, the other areas not contained within the HR ribbon maps may only include LR map data. Hence, the corridors along each candidate radio link generated between the transmitting radio unit and each receiving radio unit are a LR map embedded with a ribbon of a HR map.

As previously noted for FIG. 4, the HR ribbon maps may include a high resolution ribbon having a minimum width equivalent to a first Fresnel Zone plus a map error. Further, the HR maps may be created from aerophotos. Map error may be introduced during many stages of the map creation process. In addition, map error may include the GPS coordinate errors of the radio site. Otherwise, a HR ribbon may not fully contain the required first Fresnel zone clearance. The first Fresnel Zone for a radio signal is an ellipsoidal area immediately surrounding the visual LOS between the transmitting radio unit and each receiving radio unit. The first Fresnel Zone may vary in thickness depending on the length of the radio signal path and the frequency of the radio signal. It is preferable that a majority of the first Fresnel Zone is free from any obstruction; otherwise, a significant reduction in signal strength may be experienced. Preferably, the first Fresnel Zone should be at least 60% unobstructed.

The width of the first Fresnel Zone may also be dependent on the available area for radio unit antenna placement at each radio site or location. A radio site may be a tower, a utility pole, a water tank, part of a building rooftop or an entire building rooftop. A radio may be a LMDS base station or a CPE. If a comparatively large area is available for antenna placement, such as the rooftop of the building, a wider HR ribbon may be used so that the first Fresnel Zone of the link will be contained no matter which part of the rooftop is used for the radio antenna placement. This provides more flexibility to verify the LOS condition for the radio link to each of the available locations and find the best one for the radio antenna. However, if a site only has very limited room horizontally for antenna placement, such as a tower site, a narrower HR ribbon may be used to reduce the costs associated with mapping used for the design of the fixed radio network.

Further, the HR ribbon maps may include HR ribbons having the same ribbon width for each generated radio link, or may include HR ribbons having different widths for each generated radio link, as long as the aforementioned minimum width is satisfied.

Hence, as previously noted for FIG. 4, the HR ribbon width is a trade-off between design flexibility and map cost.

Although the HR ribbons are illustrated as having straight edges, embodiments of the present invention also include HR ribbons having various shapes and sizes.

In step 604, a LOS condition is verified for each identified candidate radio link using a respective HR ribbon map. The LOS condition may only be verified using the HR ribbon maps. Hence, other non-HR maps are unable to verify the LOS condition of the radio links identified between the transmitting radio unit and each receiving radio unit.

In step 605, a determination is made whether the LOS condition is satisfied for each identified candidate radio link.

In step 606, all identified candidate radio links failing to satisfy the LOS condition are removed upon which a design of the fixed radio network is concluded at step 607.

It is to be understood that in the aforementioned embodiments of the present invention, the steps are performed in the sequence and manner as shown although the order of some steps and the like may be changed without departing from the spirit and scope of the present invention.

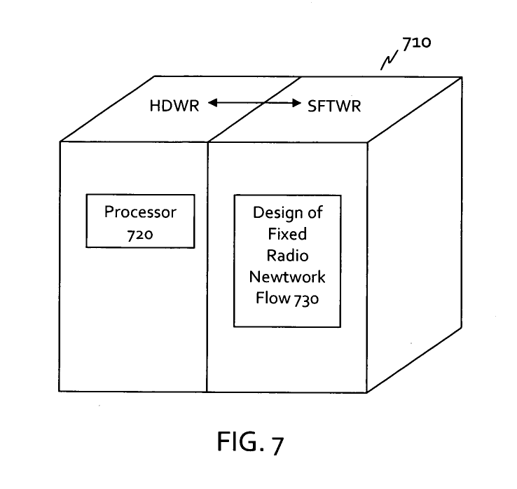

FIG. 7 illustrates an embodiment of the present invention that is a computer program product embodied on a computer readable medium, the computer program being configured to control a processor to perform at least the method described in FIG. 4 and the method described in FIG. 6, in accordance with an embodiment of the present invention. The computer program product may be embodied on a computer readable medium 710. The computer program product may included a computer program configured to control a processor 720 to perform a design of a fixed radio network flow 730, which may also be stored on the computer readable medium 710.

As shown in FIG. 7, the computer program product may be implemented using hardware, software, or a hybrid of software and hardware. The computer program product may be composed of modules that are in operative communication with one another. The computer program product may be configured to operate on a general purpose computer or an application used in RF planning tools.

The many features and advantages of the invention are apparent from the detailed specification and, thus, it is intended by the appended claims to cover all such features and advantages of the invention which fall within the true spirit and scope of the invention. Further, since numerous modifications and changes will readily occur to one having ordinary skill in the art, it is not desired to limit the invention to the exact construction and steps illustrated and described, and accordingly all suitable modifications and equivalents may be restored to, falling within the scope of the invention.

We claim:

1. A method, comprising:
generating a low resolution map for designing a coverage area between a transmitter and at least one receiver;
identifying at least one radio link between the transmitter and each of the at least one receiver;
acquiring a high resolution ribbon map for each radio link identified between the transmitter and each of the at least one receiver;
verifying a line of sight condition for each identified radio link using a respective high resolution ribbon map;
determining if the line of sight condition for each identified radio link is satisfied; and
concluding a design of a fixed radio network between the transmitter and the at least one receiver when the line of sight condition is verified for each identified radio link, or the line of sight condition cannot be verified for any of the identified at least one radio link.

2. The method of claim 1, further comprising:
determining if a new radio link is required, when the line of sight condition is not satisfied for each identified radio link; and
generating the new radio link when determining the new radio link is required.

3. The method of claim 2, further comprising:
determining if a new high resolution ribbon map is required for each new radio link, when the new radio link is determined to be required; and
acquiring the new high resolution ribbon map when determining the new high resolution ribbon map is required for each new radio link.

4. The method of claim 3, further comprising:
verifying a line of sight condition for each new generated radio link using a respective new high resolution ribbon map.

5. The method of claim 4, further comprising:
iteratively repeating the determining if the new radio link is required and the generating the new radio link, the determining if the new high resolution ribbon map is required for each new radio link and the acquiring the new high resolution ribbon map if required, and the verifying the line of site condition for each new generated radio link until each generated radio link between the transmitter and each of the at least one receiver is satisfied for designing the fixed radio network between the transmitter and each of the at least one receiver.

6. The method of claim 1, wherein the acquiring the high resolution ribbon map comprises acquiring a high resolution ribbon for the radio link identified between the transmitter and each of the at least one receiver, the high resolution ribbon comprising a minimum width equivalent to a Fresnel zone plus a map error.

7. The method of claim 6, wherein the acquiring the high resolution ribbon comprises acquiring the high resolution ribbon comprising the minimum width equivalent to the Fresnel zone plus the map error,
wherein a radius of the Fresnel zone is dependent on a frequency of the radio signal and the radio link distance between the transmitter and each identified receiver.

8. The method of claim 6, wherein the acquiring the high resolution ribbon comprises acquiring high resolution ribbon comprising a same width for each identified radio link.

9. The method of claim 6, wherein the acquiring the high resolution ribbon comprises acquiring high resolution ribbon comprising a different width for each identified radio link.

10. The method of claim 6, wherein the acquiring the high resolution ribbon comprises increasing the minimum width of the high resolution ribbon when multiple locations at a site are available for a radio antenna.

11. The method of claim 6, wherein the Fresnel zone comprises a plurality of Fresnel zones.

12. The method of claim 11, wherein the Fresnel zone is a first Fresnel zone.

13. A method, comprising:
generating a mixed resolution map for designing a coverage area between a transmitter and at least one receiver;
identifying at least one radio link between the transmitter and each of the at least one receiver;
acquiring a high resolution ribbon map for each radio link identified between the transmitter and each of the at least one receiver;
verifying a line of sight condition for each identified radio link using a respective high resolution ribbon map;
determining if the line of sight condition for each identified radio link is satisfied; and
concluding a design of a fixed radio network between the transmitter and each of the at least one receiver when the line of sight condition is satisfied for each identified radio link, or the line of sight condition cannot be verified for any of the identified at least one radio link.

14. The method of claim 13, wherein the generating the mixed resolution map comprises generating at least one high resolution map for an area comprising a dense urban area and generating at least one low resolution map for an area comprising at least one of a suburban area and a rural area.

15. The method of claim 13, further comprising:
determining if a new radio link is required, when the line of sight condition is not satisfied for each identified radio link; and
generating the new radio link when determining the new radio link is required.

16. The method of claim 14, further comprising:
determining if a new high resolution ribbon map is required for each new radio link, when the new radio link is determined to be required; and
acquiring the new high resolution ribbon map when determining the new high resolution ribbon map is required for each new radio link.

17. The method of claim 15, further comprising:
verifying a line of sight condition for each new generated radio link using a respective new high resolution ribbon map.

18. The method of claim 17, further comprising:
iteratively repeating the determining if the new radio link is required and the generating the new radio link, the determining if the new high resolution ribbon map is required for each new radio link and the acquiring the new high resolution ribbon map, and the verifying the line of site condition for each new generated radio link until each generated radio link between the transmitter and each of the at least one receiver is satisfied for designing the fixed radio network between the transmitter and each of the at least one receiver.

19. A method, comprising:
generating a low resolution map for designing a coverage area between a transmitter and at least one receiver;
identifying at least one candidate radio link between the transmitter and each of the at least one receiver;
acquiring a high resolution ribbon map for each candidate radio link identified between the transmitter and each of the at least one receiver;
verifying a line of sight condition for each identified candidate radio link using a respective high resolution ribbon map; and
removing each identified candidate radio link failing to satisfy the verified line of sight condition for designing a fixed radio network between the transmitter and each of the at least one receiver.

20. The method of claim 19, wherein the acquiring the high resolution ribbon map comprises acquiring a high resolution ribbon for each candidate radio link identified between the transmitter and each of the at least one receiver, the high resolution ribbon comprising a minimum width equivalent to a Fresnel zone plus a map error.

21. The method of claim 20, wherein the acquiring the high resolution ribbon map comprises acquiring the high resolution ribbon comprising the minimum width equivalent to the Fresnel zone plus the map error,
wherein a radius of the Fresnel zone is dependent on a frequency of the radio signal and the candidate radio link distance between the transmitter and each of the at least one receiver.

22. The method of claim 13, wherein the Fresnel zone comprises a plurality of Fresnel zones.

23. The method of claim 13, wherein the Fresnel zone is a first Fresnel zone.

24. A computer program product embodied on a computer readable medium, the computer program being configured to control a processor to perform:
generating a low resolution map for designing a coverage area between a transmitter and at least one receiver;
identifying at least one radio link between the transmitter and each of the at least one receiver;
acquiring a high resolution ribbon map for each radio link identified between the transmitter and each of the at least one receiver;
verifying a line of sight condition for each identified radio link using a respective high resolution ribbon map; and
determining if the line of sight condition for each identified radio link is satisfied; and
concluding a design of a fixed radio network between the transmitter and each of the at least one receiver when the line of sight condition is satisfied for each identified radio link, or the line of sight condition cannot be verified for any of the identified at least one radio link.

25. The computer program of claim 24, further configured to control the processor to perform:
determining if a new radio link is required, when the line of sight condition is not satisfied for each identified radio link;
generating the new radio link when determining the new radio link is required;
determining if a new high resolution ribbon map is required for each new radio link, when the new radio link is determined to be required; and
acquiring the new high resolution ribbon map when determining the new high resolution ribbon map is required for each new radio link.

26. The computer program of claim 25, further configured to control the processor to perform:
verifying a line of sight condition for each new generated radio link using a respective new high resolution ribbon map.

27. The computer program of claim 26, further configured to control a processor to perform:
iteratively repeating the determining if the new radio link is required and the generating the new radio link, the determining if the new high resolution ribbon map is required for each new radio link and the acquiring the new high resolution ribbon map, and the verifying the line of site condition for each new generated radio link until each identified radio link between the transmitter and each of the at least one receiver is satisfied.

28. A computer program product embodied on a computer readable medium, the computer program being configured to control a processor to perform:
generating a low resolution map for designing a coverage area between a transmitter and at least one receiver;
identifying a candidate radio link between the transmitter and each of the at least one receiver;
acquiring a high resolution ribbon map for each candidate radio link identified between the transmitter and each of the at least one receiver;
verifying a line of sight condition for each identified radio link using a respective high resolution ribbon map; and
removing each identified radio link failing to satisfy the verified line of sight condition for designing a fixed radio network between the transmitter and each of the at least one receiver.
